(19) United States
(12) Patent Application Publication
(10) Pub. No.: US 2003/0198367 A1
(43) Pub. Date: Oct. 23, 2003

(54) Method for processing digital image information from photographic images

(76) Inventors: Klaus-Peter Hartmann, Schondorf (DE); Wolfgang Keupp, Muenchen (DE); Ruth Forrester, Fuerstenfeldbruck (DE)

Correspondence Address: Karl F. Milde, Jr., Esq., MILDE & HOFFBERG, L.L.P., Suite 460, 10 Bank Street, White Plains, NY, 10606, US

(21) Appl. No.: 10/396,217

(22) Filed: Mar. 24, 2003

(30) Foreign Application Priority Data
Apr. 22, 2002 (EP) 02008918.1-1

(51) Int. Cl. G06K 9/00

(52) U.S. Cl. 382/118

(57) ABSTRACT

An automatic method for processing digital image data from photographic images, particularly of photographs containing people and portraits, includes a face-specific image processing that distinguishes itself from that used to process other images. Face-specific image processing is automatically selected when faces are identified within the image data by means of an object recognition procedure.

### BACKGROUND OF THE INVENTION

The invention relates to a procedure to process digital image data from photographic images of portraits and other facial images.

It has been usual in photography to soften portraits so that minor details such as skin blemishes not required for, or detracting from, the image disappear. For this, lenses are usually used that provide super-refracted contours instead of sharp focus. The best known of these is the soft-focus Rodenstock lens with relatively long focal lengths. The soft focus is achieved here using grid-like filters in front of the lens that, among other things, possess a diffracting effect. The soft-focus effect for any sharp-focus subject may also be achieved using parallel-plane filters whose front surface is provided with ridges that scatter incident light. Special photographic techniques must be selected in order to achieve such soft-focus effects when taking portrait photographs. If, on the other hand, a photograph is taken using a conventional lens without soft-focus characteristics, details such as small pimples or other skin inflammations appear that often detract from the overall impact of the photograph. In classical photography, these can only be corrected by retouching.

Since it is possible to digitize photographs, and to process these scanned images before printing using operator-selected image-editing programs, it is also possible to subject photographs of persons, especially portraits, to special subsequent processing in order to provide portrait photographs with artistic aspects. Thus, for example, an image processing procedure is known from the U.S. Pat. No. 6,200,738 in which the operator provides parameters according to which image-processing algorithms such as focus sharpening, density correction, color correction, etc. may be performed for a selected image shown on the screen. For images of portrait photographs, the operator uses parameters that cause reduced focus sharpening and defect reduction. Reduction in focus sharpening results in an improved image impact with portrait photography corresponding to a soft-focus portrait. In this processing program, grain size, gradation, and color parameters may be set by the operator that have proved themselves to be especially advantageous for portrait photographs. The image processed using these parameters may be shown to the operator before being printed on photographic paper so that he/she may decide whether the image is to be printed as shown, or whether additional parameter alterations are required.

This procedure is advantageous for processing individual, selected photographs, but may not be used during standard copying to photographic printers in photography laboratories.

It would be desirable if all photographs, particularly portrait photographs were to be reproduced with the optimum conditions, even when using a high-speed printer.

### SUMMARY OF THE INVENTION

The principal object of this invention is therefore to develop a photograph processing procedure for high-speed printers in which portrait photographs may be processed under special conditions optimal for these photographs.

This object, as well as other objects which will become apparent from the discussion that follows, are achieved, in accordance with the present invention, by implementing an automatic object-recognition algorithm to identify the presence of human faces in the image data and automatically selecting face-specific image processing when faces are identified within the image data.

In accordance with the invention, face-specific photographic processing is automatically selected when faces are located in the photographic image. For this, it is important that recognition of faces within the photographic data also occurs automatically so that no operator is required in order to identify a portrait photograph. Identification of faces within the photographic data occurs based on the invention using an object recognition procedure. Such object recognition procedures are known from the realm of personnel monitoring or identification control. Using such procedures in the realm of photograph processing introduces the possibility of automation of this processing procedure. A decisive advantage of such an object recognition procedure is the fact that they are fast enough to be used in photographic devices, since they usually must operate in real time for the personnel monitoring for which they were developed. Further, these procedures distinguish themselves by very high reliability, which prevents unintended processing with face-specific image processing parameters of photographs other than portraits. Thus, a high error rate of automatic parameter selection can be avoided during image processing.

Advantageously, only the grayscale values in the image data are used in the search for a face by means of an object recognition procedure. Since only density progressions are analyzed as a rule in this procedure, it is adequate to use this reduced, non-color image data set. In this manner, much computer time and capacity may be saved during image processing.

It is particularly advantageous to reduce the resolution of the image data set before application of the object recognition procedure in order to apply these algorithms, which are still relatively computer-time intensive, to less data. It is not necessary for reliable recognition of faces to search through a high-resolution image data set required for quality reproduction of the image. Much computer time may also be saved in this manner.

An object recognition procedure that is advantageous is, for example, the face-recognition procedure described in the Proceedings of the IS & T/SID Eighth-Colour Imaging Conference, which functions using flexible templates. In this procedure, general sample faces are used that are enlarged, reduced, and transposed while the operator compares them with the image data in various positions in order to identify similar structures in the compared grayscale images. A similarity value is established at the point at which the greatest coincidence between one of the selected and altered sample faces and the density progressions result in the image data. If this similarity value exceeds a certain threshold, one may assume that a face was detected in the picture. This procedure is very reliable, but is also very expensive. It may be used very well for smaller and slower copying devices within the scope of an imaging processing procedure, and for faster ones with the use of a reduced data set.

A further advantageous object recognition procedure is the procedure described in IEEE Transactions on Computers, Vol. 42 No. 3, March 1993, that operates using deformable grids. In this procedure, deformed standard grids of several comparison grids in any orientation are placed above the image data. The density progression of the grids and image content at the transformed positions are compared by comparison of Fourier transforms of the standard grid node points with the Fourier transforms of the image content at the image positions corresponding to the node points. The grid is frozen at the shape and position at which the best coincidence of deformed standard grids and image content ocurs, and a similarity value is created. As soon as the similarity value exceeds a certain threshold, it may be assumed that a face corresponding to the standard grid selected has been detected. This procedure is also very reliable, but is also comparatively computer-time intensive. For this reason, it is particularly recommended for slower copying devices, or in detection procedures in which a pre-selection of other criteria such as, for example, the presence of skin tones in the image is used.

In order to provide automatic selection of face photographs in so-called high-performance (fast) copy devices, a pre-selection of the photographs to be examined is performed before application of the object recognition procedure. This pre-selection may be performed, for example, by examining only those images in which skin tones occur. Image data that include no skin tones may be classified in advance as non-portrait photographs. In this manner, computer-time intensive object recognition procedures may be applied only to a certain number of images, which leads to the fact that the copy output performance of the device is hardly reduced. Another potential pre-selection criterion is the fact that connected skin tone areas must appear in the image data.

Pre-selection based on criteria such as the skin color may produce a pre-selection of images that potentially contain photographs of persons, particularly in automatic printers that operate very quickly. These are subsequently examined using an object recognition procedure to determine whether there are faces in the images. As soon as faces are isolated in these images, they are automatically subjected to face-specific image processing. Face-specific image processing may apply, for example, to the entire image. Thus, a photograph of a person may, for example, be correspondingly configured so that it is less sharply focused than other photographs, which would lead to a softer overall impact of the image. It may also be desirable, for example, to tone the whole image slightly redder, creating a warmer impact.

It is often more desirable, however, to use specific image processing limited to the image data of the face. This may bring about a situation in which the face transmits the desired softer, warmer impression but the remaining image details remain unchanged. This may be particularly desirable if on the one hand, a person is photographed, but on the other hand, a vacation theme is photographed. In this case, the face should be engaging, while the focus of the vacation theme, for example the Eiffel Tower, is not softened at all. This approach is realized using the invention. Only after faces in the image data are clearly identified using the object recognition procedure can they specifically be altered.

In the terminology used hereinafter, the softening or sharpening of an image will be referred to as “softening the focus” or “sharpening the focus”, respectively, of the image data. This is accomplished by known techniques such as those disclosed in the aforementioned U.S. Pat. No. 6,200,738.

It is, however, especially advantageous not to soften the focus of the entire face, but rather only the skin-tone areas of the face. This achieves the result that eyes and mouth, for example, which are not included in skin-tone areas and thus are not softened, remain highly detailed, and thus real and clear. The impression of a very sharply-focused image remains, although the skin areas appear soft, thus reducing or removing detracting details in these face areas.

Facial areas of homogenous density, i.e., areas in which there are no sharp edges, may be softened instead of skin-tone areas. Using this selection criterion, detail defects in larger facial areas are removed without reducing the clarity of eyes and mouth, or of other facial characteristics.

In photographs that are automatically identified as containing faces, it is advantageous to increase the red component in order to provide a warmer impression by the image. This causes the photographed persons to appear friendlier, making the photograph more appealing.

In order to avoid having the overall image impression seem fake, it is particularly advantageous to manipulate only the skin-tone areas. It is often desirable to redden only the skin-tone areas of the face especially if the face fills more than 20% of the total image area, which indicates that it is a portrait photograph. Thus, the face takes on a more friendly appearance without the color of the hair or scalp area being altered.

A further advantageous option to make a portrait photograph more appealing is to compensate density fluctuations of image data within skin-tone facial areas. By reducing jumps in contrast in the skin-tone areas of the face, distracting details are also reduced, and facial skin folds are also reduced. Thus, the portrait makes a bright, appealing impact.

It is especially advantageous to automatically select face-specific image processing when the face fills a larger portion of the image. In the case where persons are present in a landscape photograph whose faces appear very small, it has proven disadvantageous to process these faces. If very small faces are softened, it is possible for the all the facial features to be lost. This should not occur in any case. Therefore, using the invention, faces are first processed automatically only if the face fills more than 10% of the overall image area. Only then may it be assumed that the face dominates a sufficient portion of the image, so that it is necessary to perform face-specific processing. Thus, as soon as face size is selected as a criterion for automatic face-specific image processing, the contours of smaller faces are safeguarded and not destroyed. On the other hand, it is necessary in the case of adequately-sized faces to include targeted artistic formation aspects in the image that affect the face and the person. For this reason, face size is determined using the invention as soon as a face is identified within the image data. Subsequently, the portion of the face image with respect to the total image area is transmitted, and is compared with a threshold value above which face-specific image processing is automatically selected. A relative portion of at least 10% of the face has proved advantageous. It is also possible to select a larger or smaller value, depending on what the operator considers to be advantageous. This may also be linked to what image data are contained in the image besides the face. If the image contains much detailed information outside the face, it may be assumed that the face or the person is only a secondary part of the image, and the intention was not to take an actual portrait photograph. In this case, it is more desirable to increase the factor on which the selection of automatic image processing is based. If, on the other hand, the image includes very little detailed information outside of the face, it may be assumed that the photograph was mainly intended to represent the person. In this case, it may be desirable to select face-specific image processing even with the face representing less than 10% of the overall image surface.

It is particularly advantageous to provide various face-specific image-processing options that are selected dependent on the size of the face, and thus the dominance of the person in the image. Thus, for example, face-specific image processing may be selected that refers to the image as a whole for a face size of less than 10% of the image area. In this case, for example, the focus of the entire image may be softened, or the entire image may be made a little redder, or other image manipulations may be performed on one person. If the image surface is more than 10%, manipulations may be performed that apply only to the face or to the person. In this case, the photograph is classified as a portrait, since it may be assumed with a face size of more than 10% that the face or the head takes on a very dominant role in the photograph. If the face size exceeds more than 20%, on the other hand, the photograph is classified as a large portrait. In this case, the portrait really is dominant, and additional information included in the photograph is merely background. It was obviously the intention of the photographer to take an actual portrait in which the face of the photographed person is represented to best advantage. The percentages given here are guidelines that have proved themselves to be advantageous, but may be varied depending on the operator's taste.

As soon as it has been determined through face size that a large portrait photograph is involved, it is very advantageous to select an image processing procedure based on the invention that lends the necessary artistic aspects to a pure portrait photograph. It is particularly advantageous here to center the portrait face within the image. It often occurs with amateur photographs that the portrait is not properly positioned within the image. But since it is supposed to be the central component of the photograph, it is very advantageous for it to be centered. This is ensured during the processing procedure. It is also advantageous to format the entire image so that an ideal ratio between face and background is achieved. Thus, for example, a face whose area exceeds 20% but is surrounded by a very homogenous background with very little image information may be enlarged in order to ensure that the face is better reproduced while the neutral background is reduced to a reasonable size. It can often be worthwhile in a portrait photograph to subject the entire image to soft focus, which ensures that the face is softened and that detracting details disappear, but on the other hand ensures that details detracting from the portrait photograph located in the background are less sharp and thereby less dominant, which in turn directs the portrait to the center of attention, resulting in a more attractive picture. If no strong, detailed information is present in the background, it is often worthwhile to leave the original background alone and process only facial features.

In a portrait photograph in which the face represents a large portion of the image area, it is advantageous not to soften facial features such as eyes and mouth, or nose or eyebrows, but rather either leave them as in the original, or even to sharpen them more in order to create a more bright impression of these features. This creates a bright, sharp impression when the photograph is viewed, despite the fact that homogenous skin areas have been softened in order to eliminate detracting details.

It is additionally advantageous to treat the immediately-surrounding environment, particularly the hair, exactly the same as facial features, and either leave them as in the original or sharpen them additionally. This also creates the impression of a bright, sharp image although some areas of the image have been softened.

An additional very advantageous measure for automatic processing of a portrait is to slightly darken extremely bright facial skin areas. This makes it possible to automatically retouch distracting glare in the portrait photograph thus making the face looks even softer and more homogenous.

An additional very advantageous measure is to soften the environment surrounding the face, particularly the area outside the sharpened hair area, all the way to the edge of the image so that the impression of a filter is created. This technique is generally used by studios in portrait photographs to draw the viewer's attention to the portrait. This is used, however, only in a very dominant portrait, since this measure obviously alters the background greatly, not to mention noticably forcing it backward.

For a full understanding of the present invention, reference should now be made to the following detailed description of the preferred embodiments of the invention as illustrated in the accompanying drawings.

### BRIEF DESCRIPTION OF THE DRAWINGS

FIGS. 1a, 1b and 1c, taken together are a flow chart of an image processing procedure based on the invention.

### DETAILED DESCRIPTION OF THE PREFERRED EMBODIMENTS

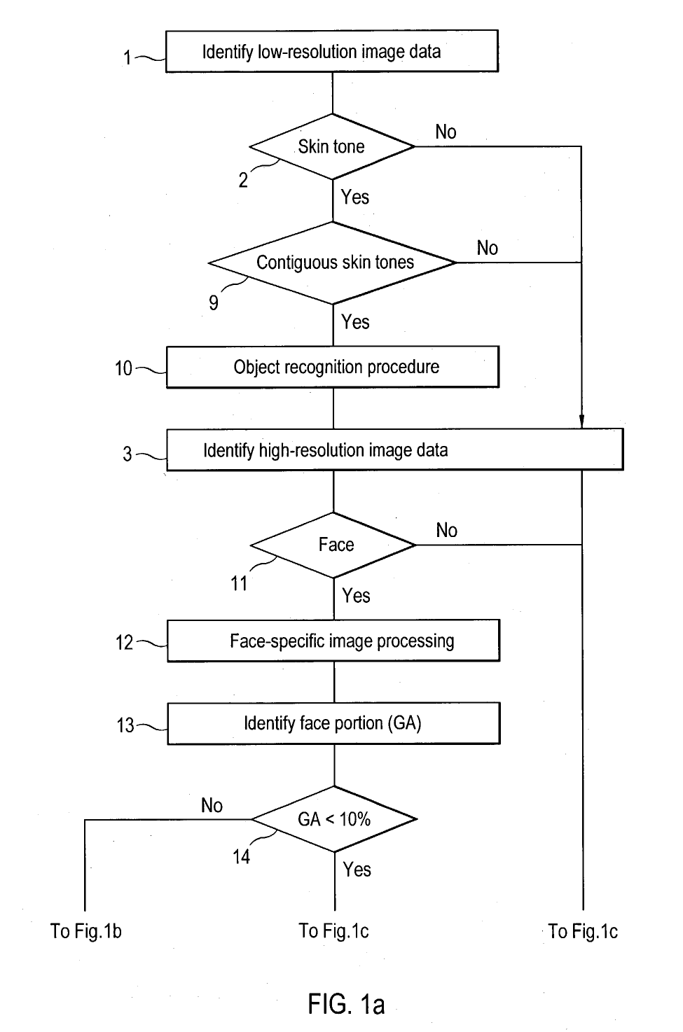

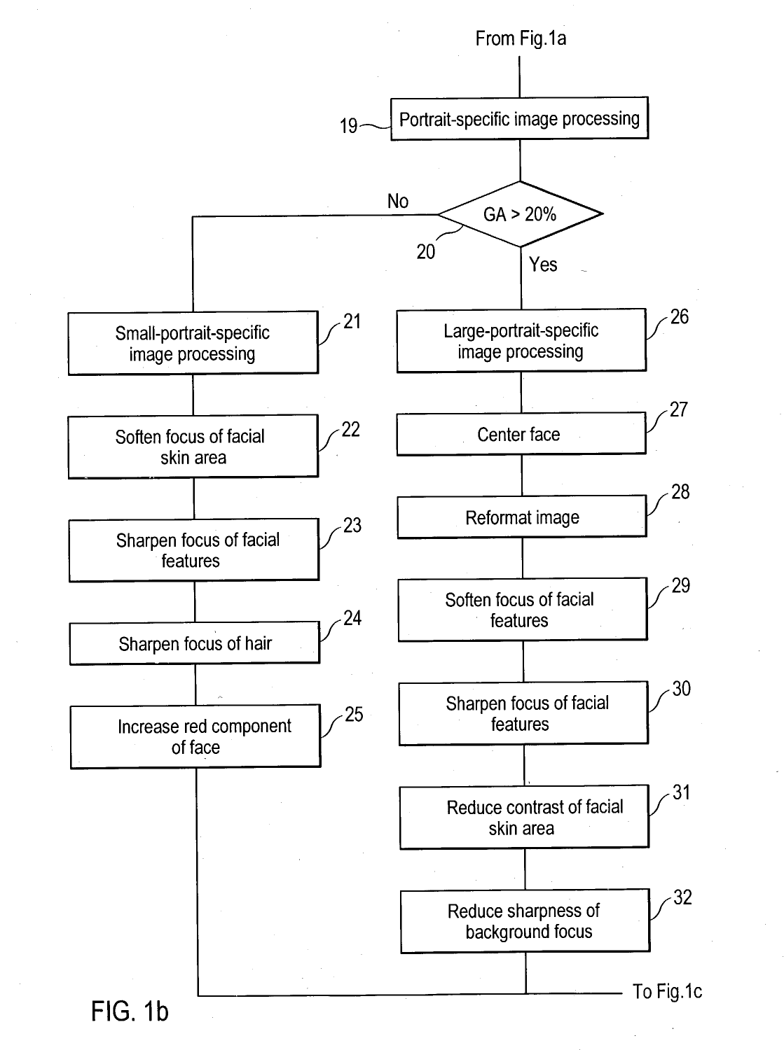

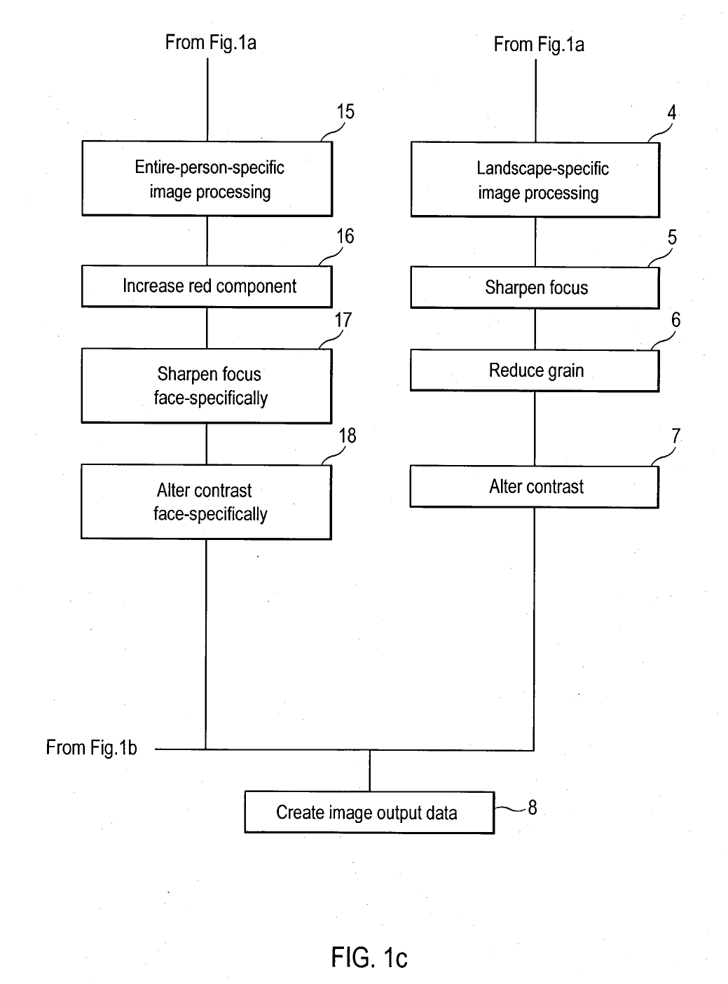

The preferred embodiments of the present invention will now be described with reference to FIGS. 1a-1c of the drawings. Identical elements in the various figures are designated with the same reference numerals.

In the first step of the image processing procedure, low-resolution image data are identified. This may occur, for example, by means of a pre-scan of the photographic film. In this case, the image data are identified by means of a fast-sampling, low-resolution scanner, generally a line scanner. Low-resolution image data may also, however, be identified in that the photographic film is sampled at high resolution, with image data stored for later application, and a low-resolution data set created from this high-resolution data set. This approach is worthwhile if only one sampling device is used in the equipment, or when digital information already exists, for example from a digital camera. This low-resolution data set is used for analysis of image content. Low resolution is fully adequate for this purpose, and image-processing time may be significantly reduced because only low-resolution image data are examined. Then in Step 2 the image data are further examined to determine whether skin tones are contained in the data set. If no skin tones are present, it is assumed that landscape-specific image data, or therefore a landscape, a still life, or similar photograph is involved. High-resolution image data are identified for these landscape-specific image data in that the film is re-sampled, or digital image data are retrieved from storage. This occurs in image-processing Step 3. High-resolution image data are subjected to landscape-specific image processing in Step 4. Thus, in Steps 5, 6, and 7, conventional image processing procedures such as sharpening, grain reduction, or contrast alteration may be applied. Other known image processing algorithms may also be used. In Step 8, image output data are created in that the printer-specific characteristic curves are applied to the image data. Thus, the image is ready for output, and may be reproduced via any output medium such as monitor, photographic printer, inkjet printer, etc. On the other hand, if skin tones are identified in the low-resolution data set, then Step 9 examines whether contiguous skin-tone areas exist in the data set. If no contiguous skin-tone areas are identified, it may be assumed that the identified skin-tone point possesses this color coincidentally, and does not belong to a skin area. In this case, a landscape or similar photograph is assumed, and the landscape-specific image processing described above is applied after high-resolution image data were identified.

If, on the other hand, contiguous skin-tone areas are identified in the data set, an object recognition procedure is applied to the image data. Within the scope of this object recognition procedure, Step 10 identifies whether faces are located within the image data. Once this occurs, the pre-analysis of the image is finished, and the high-resolution data are identified anyway, even if a landscape photograph is not involved. Subsequently, in Step 11, the photograph is characterized as a landscape-specific or face-specific photograph. If no face is present, a landscape-specific photograph is involved, and the proper image processing described above is applied. If, on the other hand, a face was identified via the object recognition procedure, then face-specific image processing is begun in Step 12. For this, the face portion of the image data is identified in Step 13. This step determines the percentage of the face to the overall image area, and makes a determination whether the face is dominant in the image, or whether the image may be treated as a portrait photograph, or whether the faces are small and in the background, so that it may be assumed that persons were photographed, but either a group is involved, or the person was photographed in connection with other themes. All this happens in Step 14 as soon as it is determined the facial portion is less than 10% of the overall image area.

In this case, a vacation or similar theme may be identified by a group of persons or by the photograph of an entire person. Whole-person-specific image processing may be initiated in Step 15. In this processing, face-specific image processing may be used in Steps 16, 17, and 18. Thus, for example, the red component of the entire photograph, or, depending on taste preferences of the operator, only that of the face may be increased in order to lend a warmer impact to the overall image.

Further, face-specific sharpening parameters may be selected that, for example, cause less softening than with landscape-specific image processing. Thus, detailed information in the image is given higher priority, but the face portions of the persons is not too strongly hardened. Face-specific contrast alteration is also desirable for a photograph of an entire person. It may be advantageous here to undertake contrast reduction in the faces so that, for example, oblique shadows in faces are reduced. In principle, it is possible, to modify all applied image processing steps so that they have a particularly positive effect on persons after a photographs identification as a whole-person photograph.

If in Step 12 while within the scope of the face-specific image processing a face portion is identified that occupies over 10% of the image area, then portrait-specific image processing is applied in Step 19. Then Step 20 checks whether the face portion exceeds 20% of the area or not. If the face portion is less than 20%, small-portrait-specific image processing is activated in Step 21. In this step, it is assumed that the photographer wished to take a portrait photograph that is not supposed to dominate the image completely. Thus, the goal of small-portrait-specific image processing is to improve the portrait, but to leave the remaining image content essentially unchanged. Small-portrait-specific image processing steps consist, for example, of softening the skin areas of the identified face in Step 22. Softening of digital data is performed by the use of filters over the image points of the face. The high-frequency portions of the image data lying within the face and possessing skin tones are essentially eliminated. All algorithms that result in lower-frequency, softened image data may be used here. In Step 23, the facial features such as eyes, mouth, and nose are sharpened or left sharp, and are excluded from softening. These facial features may either be identified during the object recognition procedure or after recognition of the face, perhaps using an edge-detection procedure. When the face is softened, it is essential to leave the facial features sharp or to sharpen them in order to maintain a brilliant impact for the overall image. For example, hair might be sharpened in Step 24. This means that a sharpening algorithm is applied to the area immediate surrounding the face. Additionally, in Step 25, the red component within the face might be increased in order to create a warmer overall impression. Any number of additional manipulations that have long been known to the photographer are possible here in order to create especially pleasing portraits. For example, progressive filters may be used, or portrait images may be progressively softened all the way to the edge, etc. After application of the small-portrait-specific image processing, image output data are also subsequently created by application of printer characteristic curves in Step 8.

On the other hand, if the identified face portion comprises more the 20% of the overall image surface, it may be assumed that a pure portrait photograph is the case, and large-portrait-specific image processing is started in Step 26. The goal of large-portrait-specific image processing is to convert the photograph into a large portrait that is artistically significant. Here, the face is shifted to the center of the photograph in Step 27, for example. The image may be reformatted in Step 28 in order to realize an optimal ratio of face to background. Thus, the face is placed into the center of attention in a proper ratio, even if the photographer did not manage to do this. Measures to be applied here include the so-called Golden Mean or other ratio values known in artistic circles. Also, it is desirable in a large portrait to soften the skin portions of the face in Step 29, and to leave sharp, or to sharpen, facial features in Step 30 so that distracting details in the face are eliminated while facial characteristics are strongly enhanced. It is also often desirable to reduce contrast in skin-tone facial areas. Oblique shadows and skin folds may thus be reduced, which also creates a friendly impression of the face. Since it is assumed that a pure portrait photograph was intended when the face portion exceeds 20%, it may also be assumed in this image that the background has no strong relevance. It is therefore advantageous to soften the background in Step 32. For this, however, one must ensure that hair surrounding the face is sharpened, and that softening begins outside the hair. This leaves a brighter image. It would also be possible to apply softening away from the face toward the edge of the image. Large-portrait-photographs may also be subjected to various other known portrait enhancements. It may be advantageous, for example, to increase the red component within the face or in the overall image, or to reduce the graininess of the image data particularly in the face, or to undertake other known enhancements. Image output data are again created in Step 8 after application of large-portrait-specific image processing.

It should be noted that with this embodiment example all image processing procedures in the landscape-specific areas of the portrait-specific image processing or of other image processings may also be performed in parallel. This makes it possible to save more computer time. It would also be possible to apply the same image processing to all image data with sharpening, grain reduction, contrast alteration, etc. to all image data, and subsequently to identify those images containing faces and to process them additionally as face-specific. In this case, the portrait- and face-specific image processings would be applied in addition to the conventional image processing. In principle, division into small-portrait, large-portrait, and entire-person photographs based on the face component may be performed using other percentage components. The components given here have proved to be especially advantageous, however. The important thing is that, after identification of a face, the size of the face component with respect to the overall image is identified so that portrait- or face-specific image processing is performed only above a certain facial size, and is not applied to every small face since they do not benefit from it.

There has thus been shown and described a novel method for processing digital image information from photographic images which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. Method for processing digital image data of photographic images, whereby image data from the photograph of a person are processed by means of face-specific image processing that distinguishes itself from processing used to process other image data, the improvement comprising the steps of implementing an automatic object-recognition algorithm to identify the presence of human faces in the image data and automatically selecting face-specific image processing when faces are identified within the image data.

2. Method as in claim 1, wherein the object recognition algorithm identifies faces based on gray-scale image density progressions in image data typical of faces.

3. Method as in claim 1, wherein the object recognition algorithm is applied to a reduced-resolution image data set in order to save computer time.

4. Method as in claim 1, wherein the object recognition algorithm includes the step of comparing the image data to a plurality of templates.

5. Method as in claim 1, wherein the object recognition algorithm includes the step of using deformable grids.

6. Method as in claim 1, wherein the object recognition algorithm is applied only to pre-selected images.

7. Method as in claim 1, wherein the focus of face image data is softened during face-specific image processing.

8. Method as in claim 7, wherein the focus in skin-tone areas of the face is softened.

9. Method as in claim 7, wherein the focus is softened in areas of the face in which there are no abrupt changes in density.

10. Method as in claim 1, wherein at least one of the red component of the image data is increased and the blue component is decreased during face-specific image processing in order to create a warmer impression of the image.

11. Method as in claim 10, wherein the color component of skin-tone areas of the face is altered.

12. Method as in claim 1, wherein density variations of image data within skin-tone areas of the face are made glossy during face-specific image processing.

13. Method as in claim 1, wherein face-specific image processing is automatically selected when the size of the identified face comprises more than 10% of the overall image area.

14. Method as in claim 1, further comprising the step of automatically selecting one of a plurality of face-specific image-processing options are provided whose selection occurs automatically based on the classification of photographs containing people and in dependence upon the face size.

15. Method as in claim 14, wherein a photograph containing people is classified as an entire-person photograph if the face size comprises less than 10% of the overall image area.

16. Method as in claim 14, wherein a photograph containing people is classified as a portrait photograph if the face size comprises more than 10% of the overall image area.

17. Method as in claim 14, wherein the photograph containing people is classified as a large-portrait photograph if the face size comprises more than 20% of the overall image area.

18. Method as in claim 17, further comprising the step of altering the face position in a large-portrait photograph.

19. Method as in claim 17, wherein a section of the image is reformatted to the overall image size for a large-portrait photograph such that the face and the background are in a ratio to each other ideal for a portrait photograph.

20. Method as in claim 16, wherein the focus of the overall image data, or of image data of portions of a face, is less strongly sharpened or is unsharpened for a portrait photograph.

21. Method as in claim 16, wherein the focus for the eyes is sharpened for a portrait photograph in order to give the photograph a sharp and bright appearance.

22. Method as in claim 16, wherein the focus of the hair is sharpened for a portrait photograph.

23. Method as in claim 16, wherein extremely light areas within faces are darkened for a portrait photograph.

24. Method as in claim 16, wherein the focus of the face surroundings is increasingly softened toward the edge of the image so that the background is not distracting.

25. Method as in claim 16, wherein the focus of the region of the image area immediately surrounding the face is sharpened for a portrait photograph.
